(19) United States
(12) Patent Application Publication
(10) Pub. No.: US 2018/0125302 A1
(43) Pub. Date: May 10, 2018

(54) COOKING UTENSIL FOR FLAVORING POULTRY

(71) Applicant: Charcoal Companion Incorporated, Berkeley, CA (US)

(72) Inventor: Cory Thomas Borovicka, Oakland, CA (US)

(21) Appl. No.: 15/347,690

(22) Filed: Nov. 9, 2016

(51) Int. Cl. A47J 43/18; A23L 13/70; A47J 37/07

(52) U.S. Cl. CPC A47J 43/18; A23V 2002/00; A47J 37/0786; A23L 13/70

(57) ABSTRACT

A cooking utensil for flavoring a whole bird with salt includes a salt block configured to fit into the body cavity of a bird and a base pan having a salt block holder for holding the salt block in an upright position on the base pan. A whole bird can be placed over the upright salt block in the pan such that the salt block inserts into the body cavity of the bird. The cooking utensil holds a whole bird upright and at the same time adds salt flavor to the bird as it is being cooked.

### BACKGROUND OF THE INVENTION

The present invention generally relates to cooking utensils, and particularly relates to cooking utensils for flavoring or brining a whole chicken or other bird as it is being cooked.

Brining is a known technique for flavoring or tenderizing poultry and other meat using salt. Brining is similar to the process of marination and involves steeping meat in a salt and water solution before cooking. The meat is soaked anywhere from 30 minutes to a few days, the amount of time varying based on the amount of meat being prepared and the intensity of flavor and tenderness desired. In many instances, the addition of salt is also desirable as a method of preserving the meat. The brining process is time consuming and demands considerable planning and preparation.

Alternative techniques for flavoring or tenderizing poultry with salt include the use of a brining egg or a salt slab. A brining egg is an egg-shaped nugget of salt that after being pre-heated is inserted by hand into the body cavity of a whole bird, where it dissolves as the bird is being cooked, providing added flavor. (If the egg is not pre-heated it will act as a heat sink and lose its effectiveness.) After cooking, the brining egg is removed, washed and dried in order to be reused with another bird. This process may be repeated with several birds until the brining egg is mostly dissolved. A salt slab is a large, flat chunk of salt that is placed on a stove or grill to be heated. Sliced poultry can then be cooked on the salt slab for added flavor. Like the brining egg, the salt slab can be washed and dried after cooking to be reused with other poultry, vegetables or meat until the salt slab is mostly dissolved. Both of these techniques eliminate the need to soak the poultry in a salt and water solution prior to cooking, which cuts down on planning and preparation time.

However, use of a brining egg generally involves a whole bird being laid horizontally as it is being cooked. This results in unbalanced heat exposure and requires the bird to be constantly monitored and rotated during the cooking process. The salt slab, on the other hand, requires poultry to be sliced into pieces to be cooked on the salt slab and thus the salt slab cannot be used to flavor or brine a whole bird. Use of brining eggs has another particular disadvantage, in that pre-heated eggs are hot and must be carefully handled when inserting them into the cavity of the bird.

### SUMMARY OF THE INVENTION

Briefly, the present invention provides a cooking utensil for efficiently flavoring or brining a whole chicken or other bird while it is being cooked in an upright position. The cooking utensil includes a salt block configured to fit into the body cavity of a bird and a base pan having a holder for holding the salt block in an upright position on the base pan. The utensil permits a whole bird to be inserted over a pre-heated salt block for brining without having to handle a pre-heated block of salt in any shape or form, as is the case with brining eggs.

In an illustrated embodiment of the invention, the salt block holder includes an anchor post extending upwardly from the base pan. The salt block, in turn, has an anchor hole in its bottom end that is sized to receive the anchor post. The salt block can thus be detachably anchored to the base pan by placing the salt block bottom end down over the anchor post such that the anchor post of the base pan inserts into the anchor hole of the salt block. A bird can be placed over the anchored salt block such that the anchored salt block inserts into the body cavity of the bird to hold the bird in an upright position. Holding the bird upright during the cooking process allows for balanced heat exposure and eliminates the need to regularly monitor and rotate the bird.

In the illustrated embodiment, the anchor post can either be permanently affixed to the base pan, such as by spot welding, or can be removably attached to the base pan. The anchor post can be removably attachable to the base pan directly or can be contained in or on a holding structure, which in turn is removably attachable to the base pan. For example, in one aspect of the invention the anchor post is preferably contained in a holder cup sized and shaped to receive the bottom end of the salt block. The holder cup can be provided with attachment means for removably attaching the holder cup to the base pan.

It will be understood that the salt block holder could also be provided without an anchor post. For example, a plane holder cup—one without an anchor post—could be provided on the bottom of the base pan. The plane holder cup would be configured to receive and hold the bottom end of the salt block so as to anchor the salt block to the pan and in an upright position. The plane holder cup could be permanently affixed to the bottom of the base pan or removably attached to the base pan.

A cooking utensil in accordance with the invention is thus suitable for both holding a whole bird upright and flavoring the bird as it is being cooked. By removing the salt block, the pan can be used for cooking (including barbecuing) any food items for which brining is not required or desired.

### DESCRIPTION OF THE DRAWINGS

FIG. 1 is an exploded top perspective view of a combination salt block and base pan in accordance with the invention.

FIG. 2 is a second top perspective view thereof, with the salt block anchored to the base pan.

FIG. 3 is a side elevational view thereof.

FIG. 4 is side cross sectional view thereof.

FIG. 5 is side elevational view thereof with a whole bird placed upright over the salt block of the combination salt block and base pan.

FIG. 6 is an exploded top perspective view of a second embodiment of a combination salt block and base pan in accordance with the invention, showing a salt block of a different configuration.

FIG. 7 is side cross sectional view thereof, with the salt block anchored to the base pan.

FIG. 8 is an exploded top perspective view of another embodiment of a combination salt block and base pan in accordance with the invention, showing an alternative means in the form of a holder cup for holding the salt block on the base pan.

FIG. 9A is a bottom plan view of the salt block holder cup of the embodiment shown in FIG. 8.

FIG. 9B is a side elevational view of the holder cup shown in FIG. 8.

FIG. 10 is a top perspective view of the embodiment of FIG. 8 showing the secured anchoring of the salt block to the holder cup and base pan.

FIG. 11 is a side elevation view thereof.

FIG. 12 is a side cross sectional view thereof.

FIG. 13 is side elevation view of a whole bird placed upright over the salt block of the combination salt block and base pan of FIGS. 8-12.

### DETAILED DESCRIPTION OF THE ILLUSTRATED EMBODIMENT

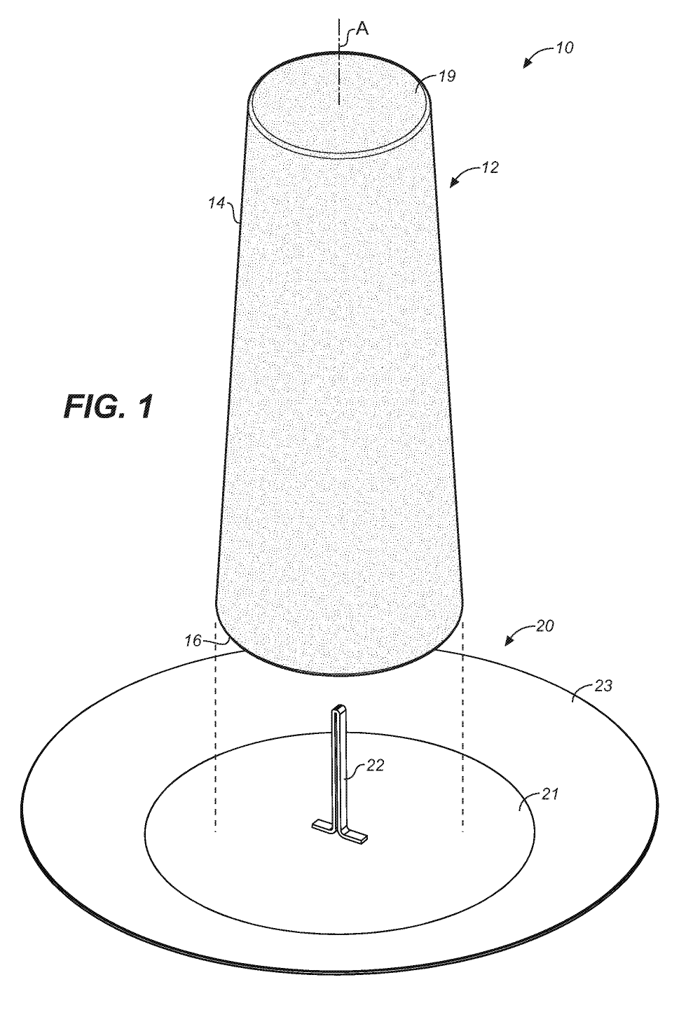

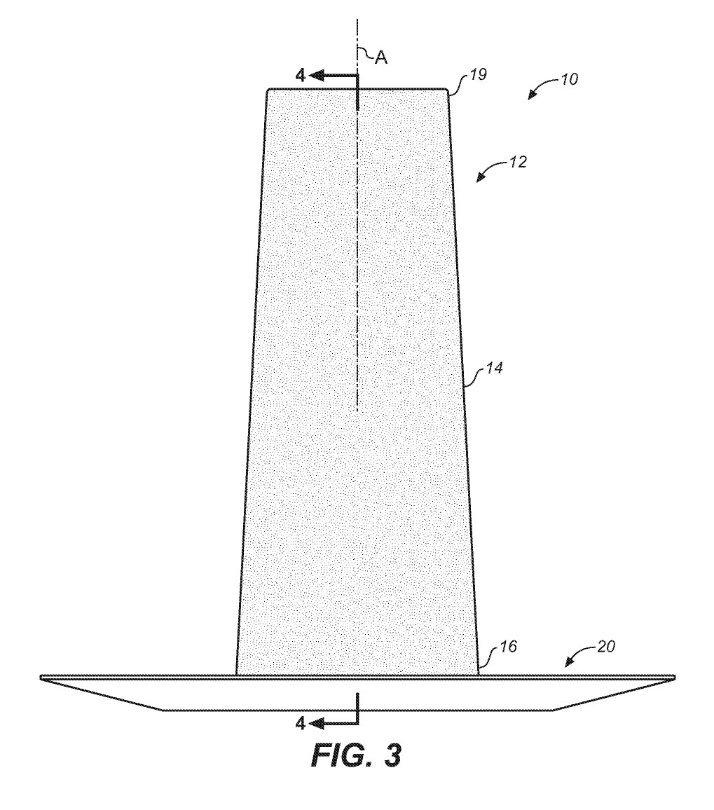

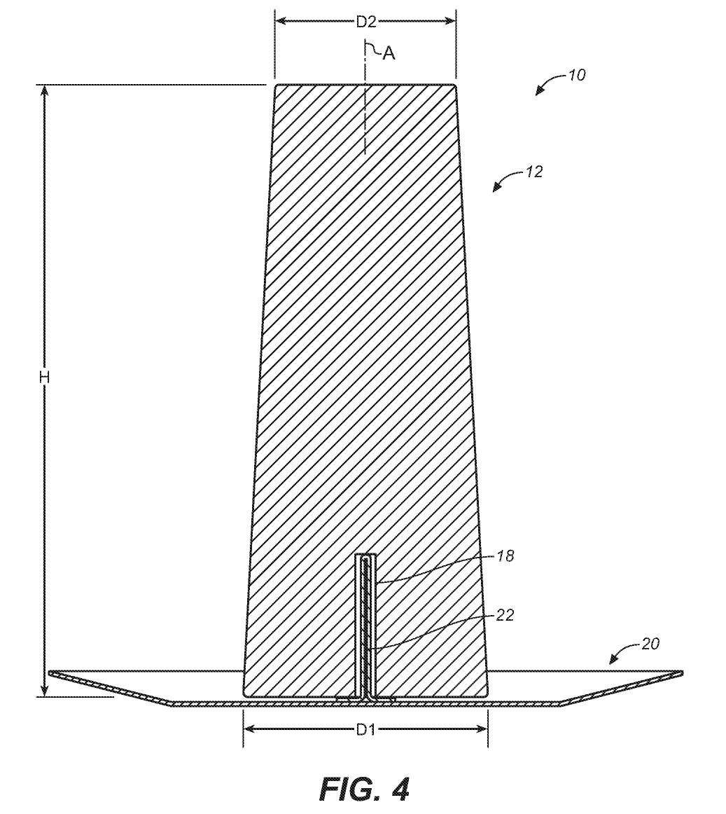

Referring now to FIGS. 1-5, a cooking utensil 10 according to the invention includes a salt block 12 and a base pan 20 having a bottom portion 21 that is suitably flat, an upturned rim 23, and an anchor post 22. The salt block 12, which can be formed of any known flavoring salt or spice such as sea salt, table salt, Himalayan pink salt, kosher salt, garlic salt, onion salt or the like, preferably has an elongated shape with a bottom end 16, a top end 19 and upwardly extending sidewalls 14 that provide a relatively large and substantially vertical sidewall surface area about the salt block's vertical axis A. In the embodiment shown in FIGS. 1-5, the salt block is seen to have a truncated cone shape. However, the salt block could be provided in other elongated shapes, such as a truncated pyramid shape, as further described below, or a straight sided cylinder or rectangular shape. Suitably the salt block is sized to be received in the cavity of a whole bird of various sizes. In the case of a typical broiler chicken, the cavity generally has a diameter of between about 2.3 inches and 3.5 inches and depth of between about 4 inches and 6 inches. A salt block for a chicken will thus suitably be sized and shaped to receive the bottom end of a salt block having a cross-sectional dimension, or dimensions, ranging from about 1 inch to about 3 inches and having a height of between about 4 inches and 6 inches. For example, referring to FIG. 4, the truncated cone-shaped salt block can have the following suitable dimensions:

Height (H)—150 mm (5.9 inches)

Bottom diameter (D1)—65 mm (2.56 inches)

Top diameter (D2)—45 mm (1.77 inches)

A tapering of the salt block from a narrower diameter at the top to a wider diameter at the bottom allows for the salt block to fit different cavity openings within a range of diameters. An elongated shape also serves to maximize the surface area of the salt block, allowing for maximum heat transfer and salt transfer into the bird. For example, the salt block of FIG. 4 can suitably have a longitudinal surface area of roughly 38 square inches and a surface to volume ratio of about 2.27.

It should be understood that the dimensions of the salt block can also be configured to fit larger whole birds, such as turkeys, or smaller whole birds, such as Cornish hens or quails.

The base pan 20 preferably has a substantially flat bottom 21 and suitably has an upturned rim 23. A vertically standing anchor post 22 preferably extends from the bottom 21 of the base pan 20 and can be either permanently affixed to the base pan 20, such as by spot welding, or detachable from the base pan.

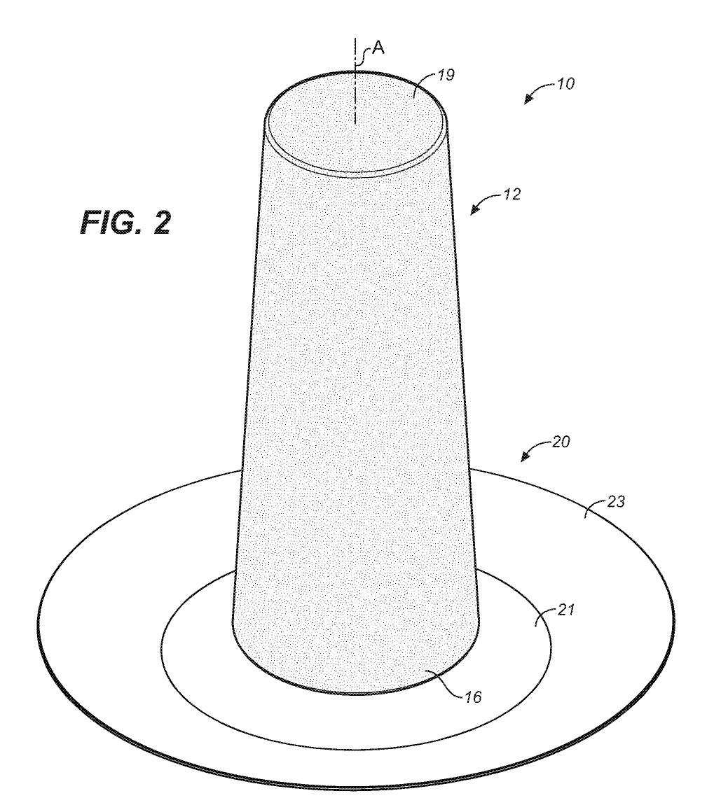

The bottom end 16 of the salt block 12 can have an anchor hole 18 (shown in FIG. 4) sized to receive the anchor post 22 of the base pan 20. As shown in FIGS. 2-4, the salt block 12 can be detachably anchored to the base pan 20 by placing the salt block bottom end down over the anchor post such that the anchor post slides within the anchor hole in the bottom end of the salt block. When anchored to the illustrated base pan 20, it is seen that the salt block 12 is tall enough to project above the rim 23 of the base pan 20. However, it is possible to provide a base pan with a rim high enough to extend above the top of the salt block, or for that matter a base pan with no rim at all.

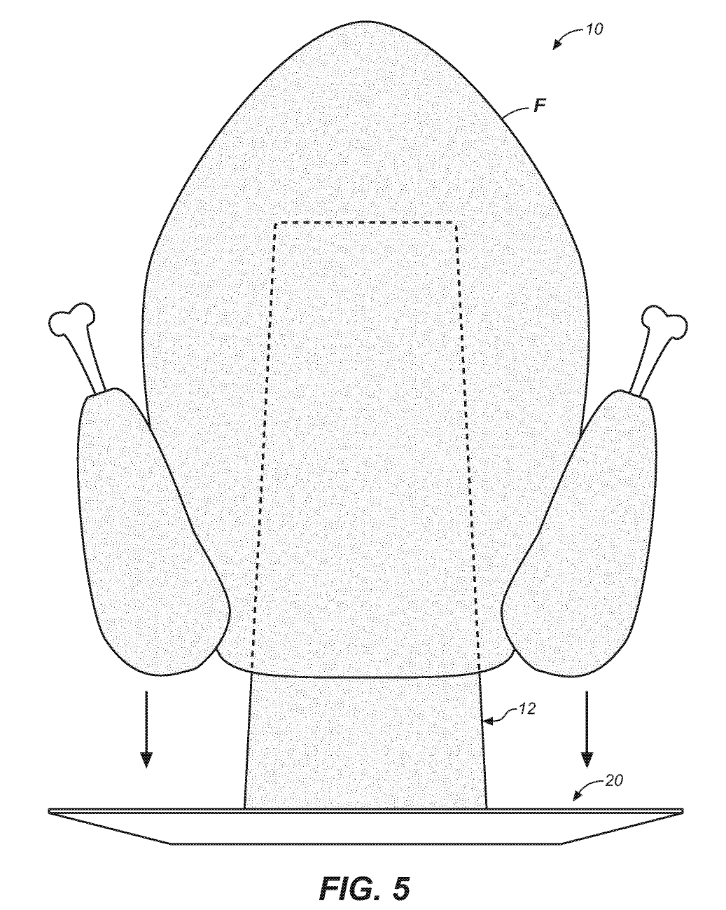

As shown in FIG. 5, a whole bird F can be placed rear end first over the top of the anchored salt block 12. As the bird is lowered, the salt block inserts into the inner cavity of the bird and supports the bird in an upright position. The tapering of the salt block from a narrower cross-sectional dimension at the top to a wider cross-sectional dimension at the bottom allows for the salt block to snuggly fit a range of cavity sizes.

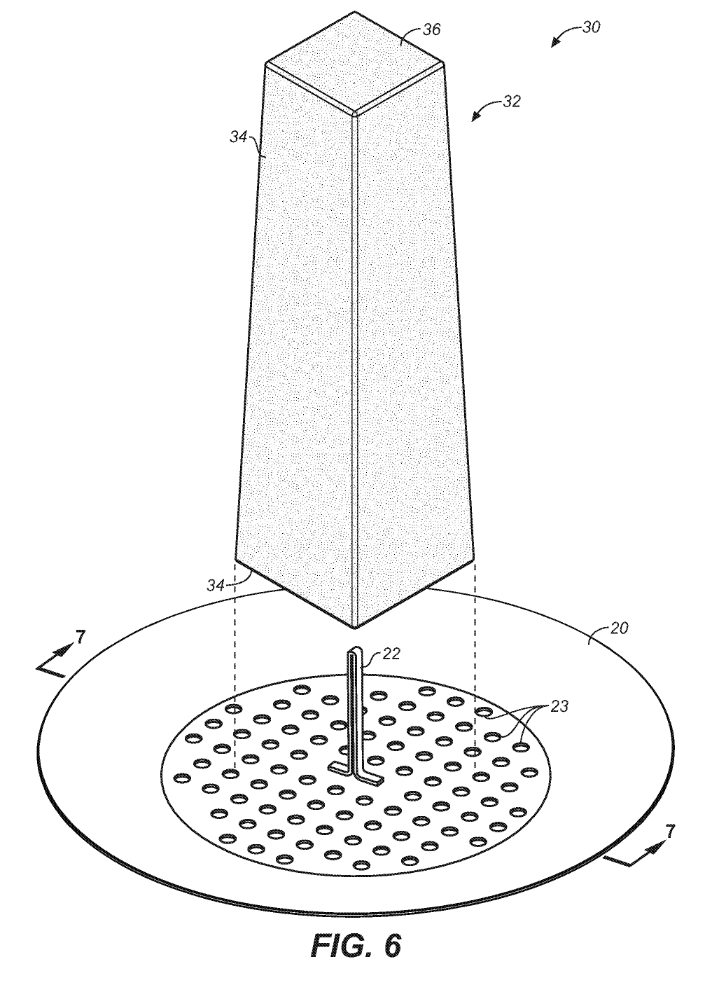

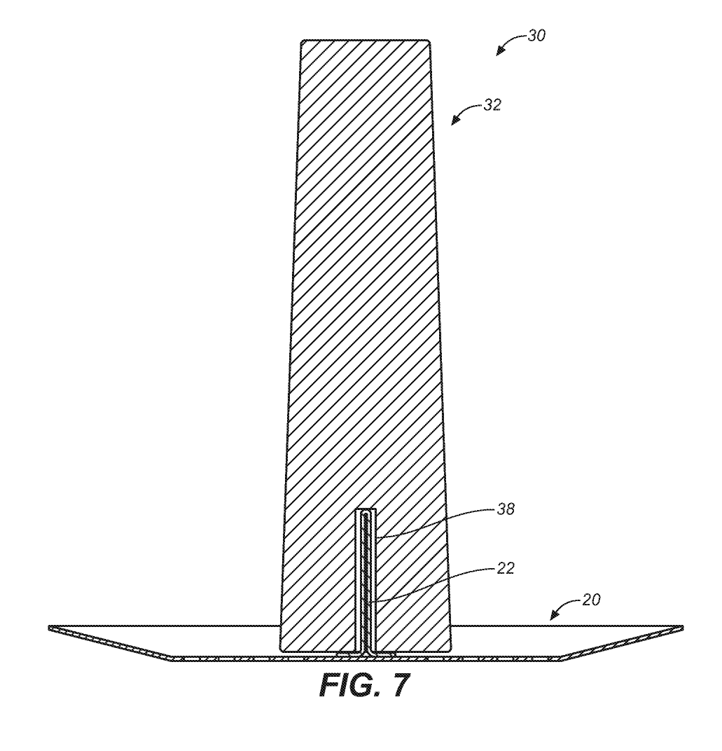

FIGS. 6-7 depict another embodiment of a cooking utensil in accordance with the invention, wherein the cooking utensil 30 includes a salt block 32 having a truncated pyramid shape that tapers from a wider bottom end 34 to a narrower top end 36. In this embodiment, the salt block 32 is similarly tall enough to insert well into the cavity of a whole bird and to support a whole bird in an upright position. The salt block 32 also similarly can have an anchor hole 38 sized to receive the anchor post 22 that projects up from the base pan. Shown in this example are optional multiple perforations 23 on the bottom of the base pan 20 that allow juices from the bird generated during the cooking process to escape from the pan.

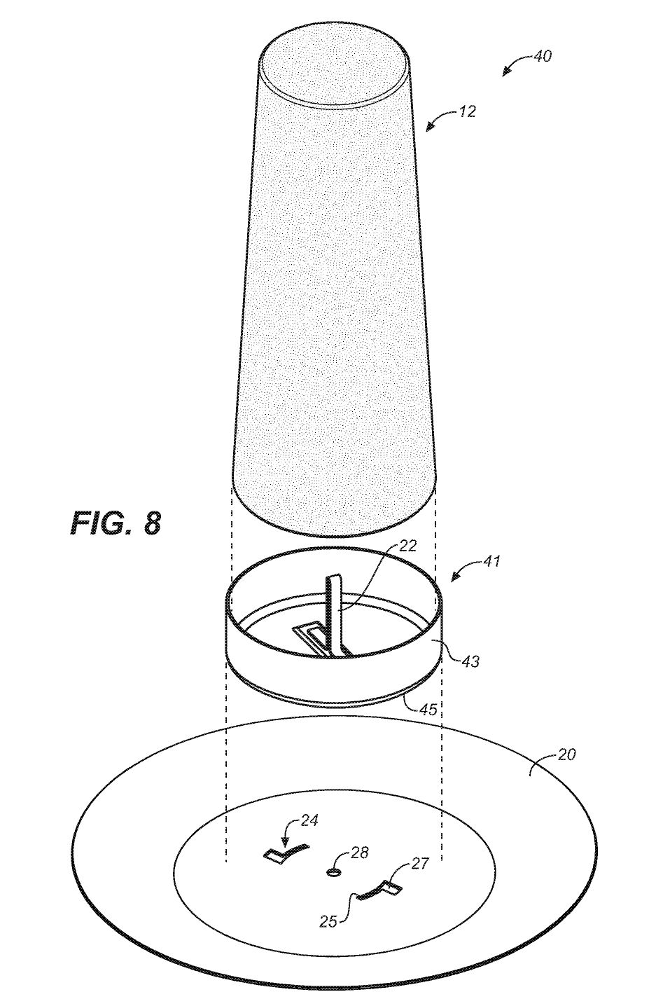

FIGS. 8-12 show another example of a cooking utensil 40 in accordance with the invention. In this example, the anchor post 22 is placed in a separate removable holder cup 41 allowing for more efficient packaging and storage of the cooking utensil. The holder cup 41 with its contained anchor post 22 can be removed from the base pan 20, allowing for the relatively flat base pan 20 to be stacked or for base pan 20 to be used for cooking other food items.

In this example, a centering hole 28 and a set of key tab receiving slots 24 are provided in the center portion of the bottom of the base pan 20. Each key tab receiving slot 24 is generally L-shaped, having an inwardly curved slot portion 25 and a wider opening 27 at one end of the slot.

The holder cup 41 can be removably attached to the center portion of the base pan 20. The holder cup 41 has upright sidewalls 43 terminating at an open top end, and has a closed bottom end 45.

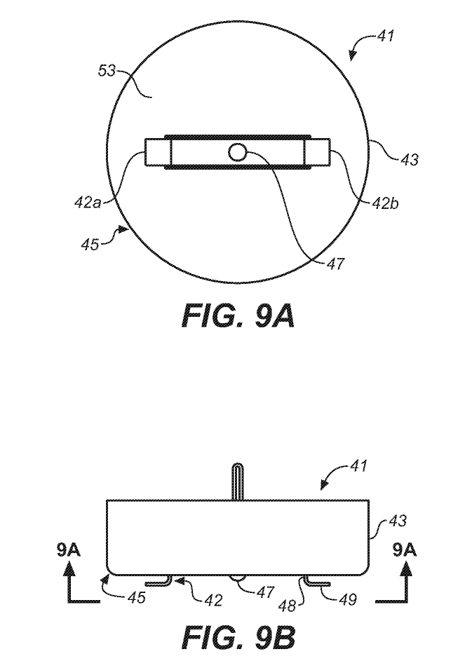

As shown in FIG. 9A, a set of oppositely disposed key tabs 42 extend downwardly from the outer portion 53 of the bottom end 45 of the holder cup 41. The key tabs 42 are arranged to align with the key tab receiving slots 24 in the center portion of the bottom 21 of the base pan 20. Each key tab 42 has a generally L-shaped profile (see FIG. 9B) provided by a substantially flat vertical part 48 and an outwardly-turned horizontal part 49. The vertical part 48 extends downwardly from the bottom end 45 of the holder cup 41 and the horizontal part 49 extends outwardly from the lower end of the vertical part 48. A positioning post 47 extends downwardly from the center of the bottom end 45 of the holder cup 41 and is sized to be received in the centering hole 28 of the base pan. This post provides an axis about which the holder cup can be rotated as described below.

The base pan 20 and holder cup 41 are fabricated from known thermally conductive materials, and can be constructed from punched or cut pieces of sheet metal and spot-welded in the desired configuration.

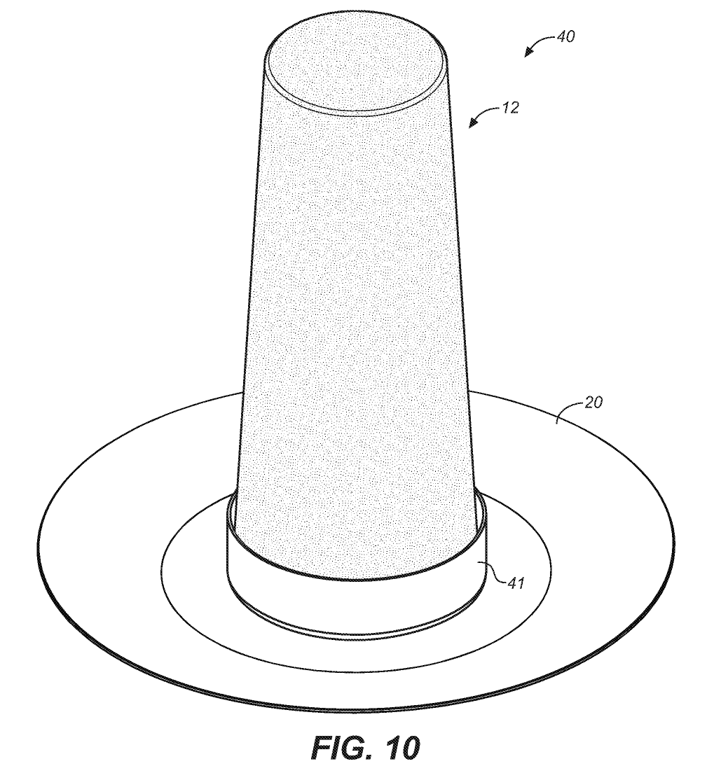

The holder cup 41 can be attached to the base pan 20 by holding the holder cup 41 in an upright position over the center portion of the base pan 20, aligning the horizontal part 49 of each of the key tabs 42 directly over the openings 27 of the key tab receiving slots 24, and aligning the positioning post 47 over the centering hole 28 in the base pan 20 as shown in FIGS. 10-12. Then horizontal parts 49 of key tabs 42 can be inserted into the opening 27 of the key tab receiving slots 24, and the positioning post 47 is inserted into the centering hole 28 to center the holder cup 41 in the base pan 20. Next, the holder cup 41 is rotated clockwise about the positioning post 47, which serves as a rotational axis, such that the vertical parts 48 of the key tabs 42 slide into the curved slot portions 25 of the key receiving slots 24, thereby locking the horizontal part 49 of each key tab 24 under the bottom side 29 of the base pan 20, and thereby securing the holder cup 41 on the base pan 20. The holder cup 41 is easily detached by rotating it counterclockwise until horizontal parts 49 of key tabs 42 are brought back into vertical alignment with the enlarged openings 27 of key tab receiving slots 24, and pulling the holder cup 41 upward to remove the key tabs 42 from the key tab receiving slots 24.

It should be understood that the holder cup 41 can be removably attached to base pan 20 by other known means, including alternative key tab configurations or fastening mechanisms or a threaded attachment.

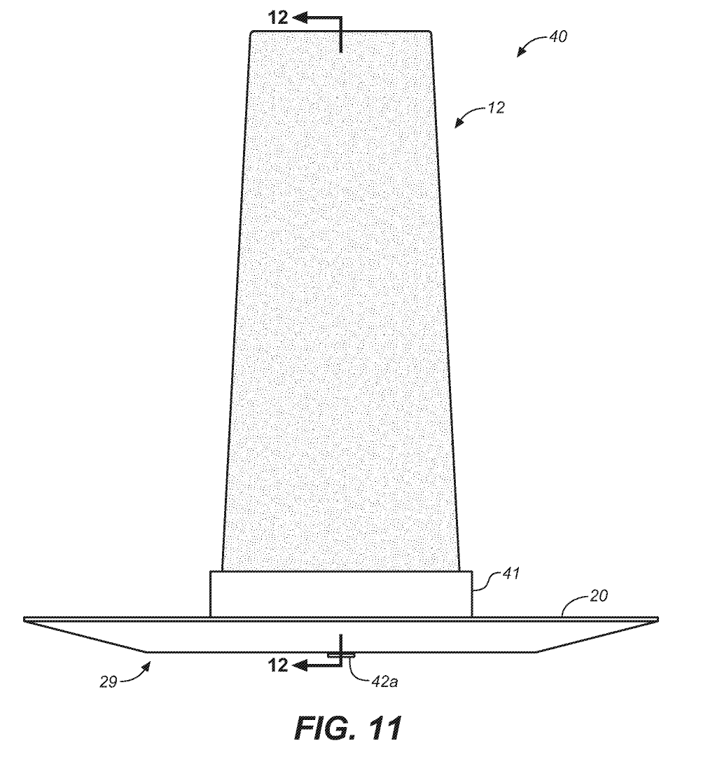

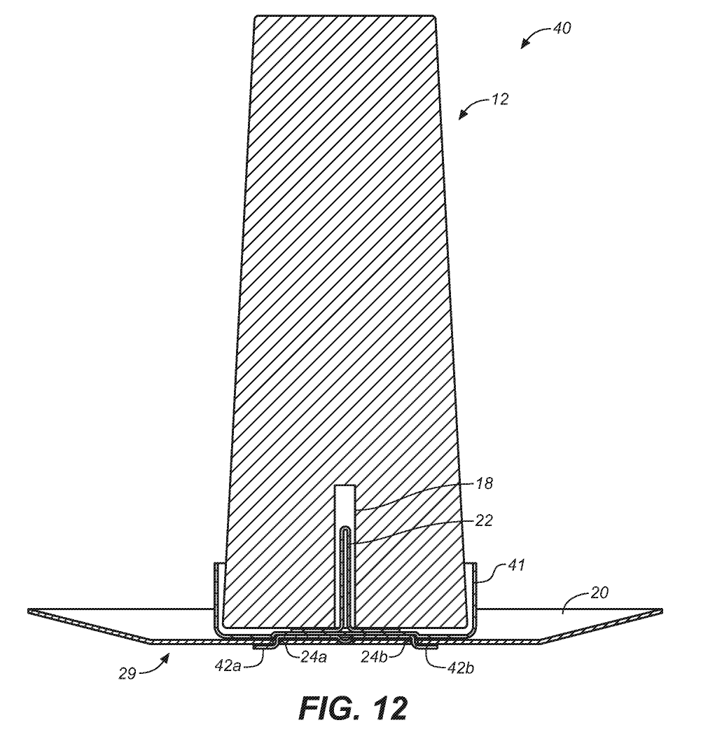

It should also be understood that the holder cup 41 can be designed without an anchor post, so long as the holder cup 41 is otherwise configured to receive the bottom end of the salt block 12 and to hold the salt block 12 upright. For example, the holder cup could be configured as a cylindrical cup having sidewalls as illustrated in FIGS. 10 and 11, only there would be no anchor post in the cup such as shown in FIG. 12. The dimensions of the holder cup 41 can be sized to snuggly fit the bottom dimensions of the salt block 12, and the upright sidewalls 43 of the holder cup 41 can be designed to have sufficient height so as to firmly support the salt block 12 in an upright position. The anchor post shown in FIG. 12 provides added stability for the salt block and greater flexibility in stably holding salt blocks of different shapes and dimensions.

Holder cup 41, as well as the base pan, is suitably fabricated as a stamped metal part, and its upright sidewalls can suitably have a height of about 145 mm (5.7 inches). It is believed this height would also be suitable for a holder cup without an anchor post; however, somewhat higher sidewalls might be selected for greater stability. Generally, it is desirable to have a holder cup with sidewalls as low as possible to minimize the coverage of the salt block but of sufficient height to maintain the stability of the salt block in its upright position. For holding a truncated cone-shaped salt block having the dimensions above-described, the holding cup would preferably be a cylindrical cup as illustrated with a suitable inside diameter of about 68 mm (2.7 inches). It will be understood that, while the shape of the holder cup would preferably conform to the shape of the base of the salt block, this is not required, so long as the cup is capable of holding the elongated block of salt in its upright position.

When using any of the example cooking utensils described, it is preferable that the salt block be pre-heated. This can be done by placing an empty utensil with its upright salt block on a barbecue grill or in an oven preheated, for example, to 350 degrees or more. Preheating the salt block provides the additional benefit of faster cooking times when compared to traditional vertical cooking of a whole bird since the hot salt block provides improved conductivity and radiant heat transfer to the inside of the bird. This added heat is usually not provided when flavoring liquids are used.

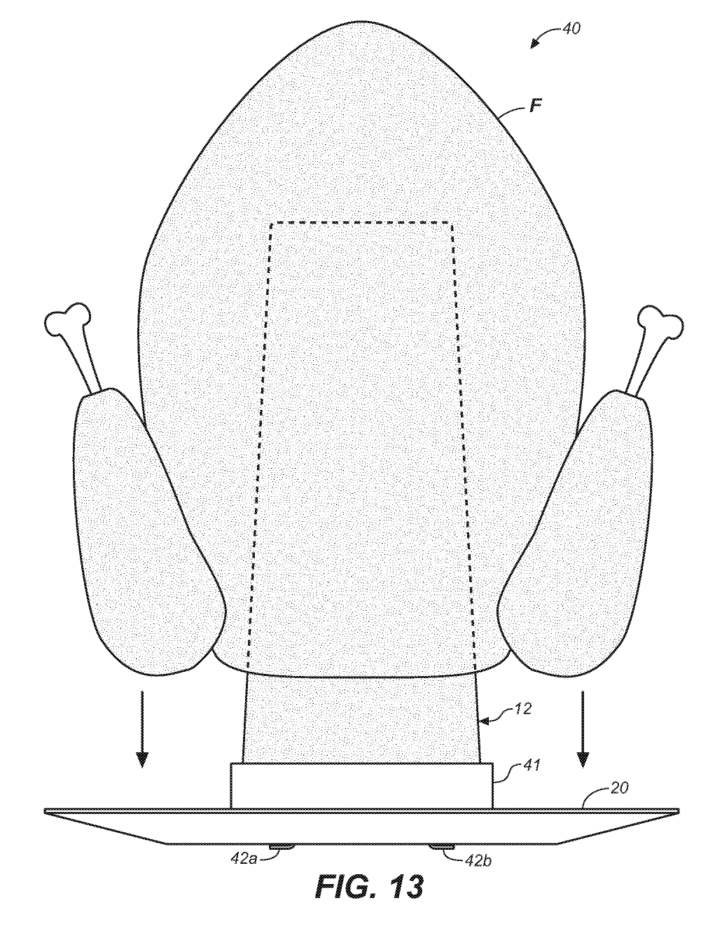

Once the salt block 12 on the base pan 20 is preheated, a whole bird F can, as best illustrated in FIG. 13, be placed rear end first over the top of the salt block 12, such that the salt block 12 inserts into the inner cavity of the bird and supports the bird in an upright position. It is noted that insertion of the salt block into the bird can be accomplished without touching or otherwise handling the hot salt block.

The upright whole bird F can then be cooked on the barbecue grill or in the oven (or on or in some other cooking appliance). Vegetables, herbs, and other food items (not shown) can be placed on the bottom 21 of the base pan 20 to cook alongside the bird. As the juices in the bird F heat up during the cooking process, the salt block 12 will dissolve, infusing the bird with salt flavor. Again, preheating the salt block 12 serves to expedite this process. Additionally, any other food items surrounding the bird will absorb drippings from the bird for added flavor.

After the cooking process is finished, the salt block 12, 32 can, after it has cooled, be removed from the base pan 20, washed and then dried in order to be reused with another bird. This process may be repeated until the salt block 12, 32 is substantially dissolved, at which point the salt block can be replaced.

It will be understood that the base pan can be used either with or without the salt block and/or holder cup to cook food items placed in the base pan, thereby adding flexibility to the cooking utensil.

The cooking utensils with removable elements as described herein can be efficiently packaged in stackable containers by removing the salt block 12, 32 and/or holder cup 41 from the base pan 20 and by laying the salt block 12, 32 on its side, in or next to the relatively flat base pan 20 and/or stacking multiple of the holder cups 41.

While the invention has been described in considerable detail in the foregoing specification and the accompanying drawings, it will be understood that it is not intended that the invention be limited to such detail, except as may be necessitated by the following claims.

What we claim is:

1. A cooking utensil for flavoring a whole bird, such as a whole chicken, having a body cavity, comprising:
a salt block having a bottom end and being configured to fit into the body cavity of a bird,
a base pan, and
means for holding the salt block in an upright position on the base pan, wherein a whole bird can be placed in the base pan over the upright salt block such that the upright salt block inserts into the body cavity of the bird and holds the bird in an upright position.

2. The cooking utensil of claim 1 wherein the holding means includes:
an anchor post extending upwardly from the base pan, and
an anchor hole in the bottom end of the salt block, wherein the anchor hole is sized to receive the anchor post extending upwardly from the base pan when the salt block is placed bottom end down over the anchor post.

3. The cooking utensil of claim 1 wherein the salt block has an elongated shape wherein the elongated shape provides elongated upwardly extending sidewalls for heat and salt transfer.

4. The cooking utensil of claim 3 wherein the salt block has a truncated cone shape.

5. The cooking utensil of claim 3 wherein the salt block has a truncated pyramid shape.

6. The cooking utensil of claim 1 wherein the base pan has a substantially flat bottom portion and a rim surrounding the bottom portion.

7. The cooking utensil of claim 6 wherein the substantially flat bottom portion of the base pan has a plurality of perforations that allow juices from the upright bird in the base pan to drain from the base pan.

8. The cooking utensil of claim 2 wherein the upwardly extending anchor post of the base pan is permanently affixed to the base pan.

9. The cooking utensil of claim 2 wherein the upwardly extending anchor post of the base pan is removably attachable to the base pan.

10. The cooking utensil of claim 2 further comprising a separate holding structure for holding the anchor post of the base pan such that the anchor post extends upwardly from the base pan.

11. A cooking utensil for flavoring a whole bird, such as a whole chicken, having a body cavity, comprising:
a base pan having a bottom portion,
a salt block having a bottom end and being configured to fit into the body cavity of a whole bird, and
a holder cup on the bottom portion of the base pan, the holder cup having upright sidewalls and being configured to hold the salt block in an upright position when the bottom end of the salt block is placed therein, wherein a whole bird can be placed in the base pan over the upright salt block such that the salt block inserts into the body cavity of the bird.

12. The cooking utensil of claim 11 wherein the holder cup is removably attachable to the bottom portion of the base pan.

13. The cooking utensil of claim 11 wherein:
the holder cup has an anchor post that projects upwardly within the holder cup,
the bottom end of the salt block has an anchor hole sized to receive the anchor post of the holder cup when the bottom end of the salt block is placed into the cup holder over the anchor post, and
the salt block is detachably anchored to the base pan by the anchor post when placed in the cup holder.

14. The cooking utensil of claim 13 wherein:
the bottom of the base pan has a plurality of perforations that allow juices from the upright bird in the base pan to drain from the base pan.

15. A cooking utensil for flavoring a whole bird, such as a whole chicken, having a body cavity, comprising:
a base pan having a bottom portion,
a salt block having a bottom end and an anchor hole in the bottom end of the salt block, and being configured to fit into the body cavity of a whole bird, and
a holder cup removably attachable to the bottom portion of the base pan, the holder cup having an anchor post that projects upwardly within the holder cup, wherein the anchor hole is sized to receive the anchor post extending upwardly within the cup holder when the salt block is placed bottom end down in the cup holder over the anchor post, and wherein a whole bird can be placed in the base pan over the upright salt block such that the salt block inserts into the body cavity of the bird and holds the bird in an upright position.
